(19) United States
(12) Patent Application Publication
(10) Pub. No.: US 2008/0219176 A1
(43) Pub. Date: Sep. 11, 2008

(54) Transmission Device

(76) Inventor: Yusuke Yamada, Nara (JP)

Correspondence Address: BIRCH STEWART KOLASCH & BIRCH, PO BOX 747, FALLS CHURCH, VA, 22040-0747, US

(21) Appl. No.: 10/589,663

(22) PCT Filed: Feb. 15, 2005
(86) PCT No.: PCT/JP2005/002258

§ 371 Date: Aug. 16, 2006

(30) Foreign Application Priority Data
Feb. 17, 2004 (JP) 2004-040307

(51) Int. Cl. H04L 12/28; H04L 12/56

(52) U.S. Cl. 370/252; 370/392; 370/230

(57) ABSTRACT

A flow calculation unit classifies packets of data to be transmitted according to each packet header. A stream data determination unit organizes a set of packets having the same packet header as a packet group according to the classified result by the flow number calculation unit, and determines whether to transmit with a bandwidth guaranteed according to the bit rate of the packet group. A bandwidth request command generation unit requests a bandwidth control device to reserve a bandwidth for the packet group determined to be transmitted with a bandwidth guaranteed by the stream data determination unit. Therefore, a bandwidth can be automatically reserved to allow data transmission even when no transmission condition is specified by the application.

### TECHNICAL FIELD

The present invention relates to the technique for transmitting data on a network with QoS (Quality of Service) ensured. Particularly, the present invention relates to a transmission device monitoring a packet flowing on a transmission path of a network that ensures QoS, and identifying the flow to be transmitted with a bandwidth guaranteed to effect a bandwidth request to a bandwidth control device.

### BACKGROUND ART

Recently, an attempt to transmit streaming data that requires real-time characteristics simultaneously with another data on a network such as a wireless LAN (Local Area Network) has been made, and is now beginning to be realized.

Since data has various properties, the transmission condition that must be satisfied during transmission will differ depending upon the data. For example, in the field of WWW (World Wide Web) and file transfer, it is required that there is no error although some transmission delay is allowed.

Streaming data such as of video and audio requires the real-time characteristics of continuously transmitting a predetermined amount of data within a delay time range that is limited. It is desirable that the delay before data reproduction (reception) is as small as possible. Further, although it is desirable that error transmission is low, an absolutely error-free event is not required.

When data having such different transmission characteristics are integrated and transmitted on a LAN, an appropriate QoS control is required. In other words, for streaming data that requires real-time characteristics, a dedicated bandwidth is ensured to allow transmission through a communication path (QoS communication path) that has communication quality ensured. This is called isochronous transmission. Other data in WWW and file transfer is to be transmitted using the remaining bandwidth. This is called asynchronous transmission.

There are some networks that support such QoS control in a data link layer, media access controller, or MAC (Media Access Control) layer. For example, IEEE (the Institute of Electrical and Electronics Engineers, Inc.) 802.11e is an extended version of the MAC layer of wireless LAN 802.11, and supports QoS control in addition to the conventional MAC control. Standardization is under development so that this IEEE 802.11e can be used in common between a PC (Personal Computer) and AV (Audio Visual) equipment.

The QoS generally includes priority-based QoS (Prioritized QoS) and parameter-based QoS (Parameterized QoS). Priority-based QoS divides the frame to be transmitted into priority categories of 4-8 stages to provide priority control by differentiating the quality of service provided for each category. Many applications on the IP correspond to priority-based QoS.

Parameter-based QoS ensure parameters such as the specified bandwidth, delay time, and the like for transmission. AV data, data of IEEE 1394, and the like correspond to parameter-based QoS.

Priority-based QoS and parameter-based QoS both allow simultaneous support. Realization is allowed by switching between a self-contained distributed control (access control scheme on the assumption of collision) and centralized control (access control scheme without collision) based on time.

As disclosed in Non-Patent Document 1, the network that supports QoS control generally has a configuration set forth below.

First, there is one bandwidth control device on the network. The bandwidth control device is a station that receives a bandwidth reservation request from each terminal on the network and allocate a bandwidth to each terminal to provide a transmission opportunity. In a wireless LAN, a base station (access point) often takes on the task of this bandwidth control device. The bandwidth control device is also called a coordinator.

The bandwidth control device continuously outputs a beacon accurately at a constant interval. The beacon interval time is divided into a CFP (Contention Free Period) and a CP (Contention Period).

During a contention free period, packet collision will not occur since each terminal will transmit data only at the transmission opportunity provided by the bandwidth control device. The bandwidth control device must notify each terminal of information to provide a transmission opportunity. The method of providing a transmission opportunity includes the method of the base station sequentially issuing polling to each terminal to notify a transmission opportunity, and the method of providing scheduling information to the beacon for broadcasting to all the terminals on the network. Parameter-based QoS data must be transmitted during the contention free period during which the bandwidth usage right is defined.

In a contention period, the terminal to conduct transmission looks for an empty status of the medium (carrier sense). If the medium is available for a predetermined time, the terminal conducts transmission after waiting for a predetermined time that is called random backoff. When two or more terminals take the same random backoff, packet collision may occur. When determination is made that packet collision has occurred, the packet is sent again. In a contention period, the base station and terminal each transmit a packet in a self-contained distributed manner. This access control scheme is called CSMA/CA (Carrier Sense Multiple Access with Collision Avoidance). The priority-based QoS data can be transmitted in the contention period. Priority control is realized through a method that sets a shorter waiting time after carrier sense (frame transmission interval) for data of higher priority.

In general, the media usage efficiency is better in a contention free period than in a contention period. This is due to the difference in the access method set forth above. Description is provided hereinafter mainly on parameter-based QoS.

Each terminal on the network issues a bandwidth reservation request to the bandwidth control device. At this stage, a QoS parameter can be set. A QoS parameter refers to information related to the transmission condition required for each data to be transmitted by the terminal. For example, it includes the data rate average, data rate maximum/minimum, the allowed longest delay time, the allowed jitter (variation) in delay time, frame size average, and the like.

For example, in IEEE 802.11e, the QoS parameter is represented quantitatively by a parameter group called TSPEC (Traffic SPECification). Although a QoS parameter is to be set from the terminal, the specification of IEE 802.11e is silent about by whom and how the QoS parameter is to be determined. Basically, the transmission condition required by each application will be specified. The MAC management entity receives the transmission condition specification from an application, and converts the same into QoS parameters applicable to its own network to ensure QoS.

If the transmission condition is not specified by the application, all data will be transmitted in the contention period. Quite a number of applications on the IP, even those handling data such as video and audio, initiate transmission without specifying the transmission condition at the start of the session. This is because many applications on the IP currently are not subject to a parameter-based QoS. Since transmission is conducted without ensuring QoS, video/audio data will be transmitted without meeting the desirable transmission quality. In other words, the QoS function of the network, even if supported therein, will not be exploited.

Since the media usage efficiency is better in a contention free period than in a contention period as set forth above, it is desirable to conduct transmission using the contention free period, if possible. This is because an aggressive usage of the contention free period will lead to improving the throughput of the entire network.

In view of the case where the transmission condition is not specified by the application, a study is made to automatically generate the optimum QoS parameter in some mechanism such as a MAC management entity to ensure QoS. There are known the inventions disclosed in Patent Document 1 and Patent Document 2 as technique related thereto.

The bandwidth control device disclosed in Patent Document 1 detects the start frame of the RTP (Realtime Transport Protocol), recognizes that an RTP session has been initiated, and extracts the required QoS parameter from the RTP header information to effect a bandwidth request.

Patent Document 1 also discloses the method of measuring the traffic amount for each transport layer protocol and transport layer port number, storing the statistics information into a memory, and requesting allocation of a bandwidth in proportion to the traffic amount to each protocol.

The data transmission method disclosed in Patent Document 2 includes the step of determining whether the data is stream data or not, and allocating a channel in response to determination of stream data to transmit data, or transmitting data under the asynchronous transmission scheme without allocating a channel in response to determination of not being stream data.

Patent Document 1: Japanese Patent Laying-Open No. 2002-247067

Patent Document 2: Japanese Patent Laying-Open No. 2000-134278

Non-Patent Document 1: 802.11 High-speed Wireless LAN Textbook (published by IDG Japan, Mar. 29, 2003, pp. 66-122)

### DISCLOSURE OF THE INVENTION

### Problems to be Solved by the Invention

Since quite a number of applications on the IP initiate transmission without specifying the transmission condition even if the network supports parameter-based QoS control in a data link layer, there was a problem that transmission is conducted without satisfying the essentially desired transmission quality in applications that handle video/audio data. Such a transmission without specifying the transmission condition will cause all data to be transmitted in the contention period, leading to degradation of the media usage efficiency.

Further, the method disclosed in Patent Document 1 is disadvantageous in that the method can be applied only to a RTP. Although the RTP is a protocol that is normally used in applications with real-time characteristics, there are some applications on the IP that do not use the RTP. For example, the protocol used in Windows (registered trademark) Media Player (registered trademark) of Microsoft (registered trademark) Corporation is TCP. When attention is focused in improving the media usage efficiency, it is desirable to reserve a bandwidth for data transmission even for a general application that has a substantially fixed bandwidth, in addition to applications that have real-time characteristics. Further, a general-purpose configuration that is adaptable to a general application is also required.

Patent Document 1 discloses the technique for measuring the traffic amount for each transport layer protocol and transport layer number port number. However, the disclosure is not practical enough since specific measures to determine that the data corresponds to streaming data is not provided.

In the data transmission method disclosed in Patent Document 2, the measure to determine that the data is streaming data is disclosed. However, there is a problem that it is not properly adaptable to an application with a variable bit rate. In accordance with the CBR (Constant Bit Rate) corresponding to the scheme to compress video and audio at a fixed bit rate, the required data rate can be calculated readily since the bandwidth is constant over a long period of time. It is easy to measure the traffic amount, and request a data rate proportional thereto. However, there is also known a VBR (Variable Bit Rate) corresponding to the scheme to compress video with a variable bit rate. Since the data rate varies over time in such an application, there is a problem that streaming data cannot be identified, or the bandwidth control device cannot properly correspond thereto even if the data rate average is requested.

The present invention is directed to solving the problems set forth above, and the first object is to provide a transmission device that can automatically reserve a bandwidth to transmit data even when a transmission condition is not specified by the application.

The second object is to provide a transmission device that can improve the media usage efficiency by conducting transmission in a contention free period, if possible.

### Means for Solving the Problems

According to an aspect of the present invention, a transmission device conducting communication with predetermined quality ensured includes a classification unit classifying a packet of data to be transmitted according to each packet header, a determination unit organizing a set of packets having the same packet header as a packet group according to the classified result by the classification unit, and determining whether to be transmitted with a bandwidth guaranteed according to the bit rate of the packet group, and a request unit requesting a bandwidth control device to reserve a bandwidth for a packet group determined to be transmitted with a bandwidth guaranteed by said determination unit.

Preferably, the determination unit includes a measurement unit measuring the bit rate per predetermined unit time of the packet group, a calculation unit calculating a parameter representing variation of the bit rate with the latest predetermined number of data to be the subject from the measured result by the measurement unit, and a packet determination unit determining that the packet group is the packet group to be transmitted with a bandwidth guaranteed when the parameter calculated by the calculation unit is at most a preset value.

Further preferably, the calculation unit increases the number of data to be the subject of calculation when the calculated parameter is larger than the preset value, and recalculates the parameter. The packet determination unit determines that the packet group is the packet group to be transmitted with a bandwidth guaranteed when the value of the recalculated parameter is at most than the preset value.

Further preferably, the calculation unit repeats calculation of the parameter while sequentially increasing the number of data to be the subject until the parameter becomes at most the preset value, or until the number of data to be the subject reaches a maximum determined in advance.

According to another aspect of the present invention, a transmission device conducting communication with predetermined quality ensured includes a classification unit classifying a packet of data to be transmitted according to each packet header, a determination unit organizing a set of packets having the same packet header as a packet group according to the classified result by said classification unit, and determining whether to be transmitted with a bandwidth of the packet group ensured, and a request unit requesting a bandwidth control device to reserve a bandwidth for a packet group. The determination unit calculates the buffer capacity required when a packet group is to be transmitted through a specific bandwidth, carries out calculation with a different bandwidth, derives the relationship between the required bandwidth and the required buffer capacity, and determines whether the packet group is to be transmitted with a bandwidth guaranteed.

Preferably, the determination unit extracts the maximum value of the buffer capacity required for each requested bandwidth, and determines whether the packet group is a packet group to be transmitted with a bandwidth guaranteed depending upon whether a graph representing the relationship between the requested bandwidth and the maximum value of the required buffer capacity is within a predetermined range or not.

Further preferably, the determination unit causes the request unit to request a bandwidth in the predetermined region, and requests a buffer unit to ensure the maximum value of the buffer capacity within the predetermined region.

Further preferably, the determination unit determines the bandwidth to be requested and the buffer capacity to be ensured such that the total cost is minimized based on the cost required to ensure a bandwidth and the cost of the buffer capacity.

Preferably, when the determination unit determines that the packet group once determined to be transmitted with a bandwidth guaranteed is not observed for a predetermined time and is no longer necessary to ensure a bandwidth, the request unit requests the bandwidth control device to release the bandwidth guaranteed for the relevant packet group.

Preferably, when there is a change of at least a predetermined criterion in the bit rate characteristics of the packet group once determined to be transmitted with a bandwidth guaranteed by the determination unit, the request unit requests the bandwidth control device to modify the bit rate of the bandwidth guaranteed for the packet group to the latest value.

Preferably, when there is a change of at least a predetermined criterion in the bit rate characteristics of the packet group once determined to be transmitted with a bandwidth guaranteed by the determination unit, the request unit requests the bandwidth control device to release the bandwidth guaranteed for the packet group.

### EFFECTS OF THE INVENTION

According to an aspect of the present invention, a bandwidth can be automatically reserved for data transmission even when the transmission condition is not specified by the application since the determination unit organizes a set of packets having the same packet header as a packet group according to the classified result by the classification unit, and determines whether the packet group is to be transmitted with the bandwidth guaranteed according to the bit rate of the packet group.

Further, since the packet determination unit determines that the packet group is a packet group to be transmitted with the bandwidth guaranteed when the parameter calculated by the calculation unit is at most the preset value, determination of whether to transmit with a bandwidth guaranteed can be readily made.

Further, since the calculation unit increases the number of data to be the subject of calculation when the calculated parameter is greater than a preset value and recalculates the parameter, determination of whether to transmit with the bandwidth guaranteed can be carried out more strictly.

Further, since the calculation unit repeats the calculation of the parameter while sequentially increasing the number of data to be the subject until the parameter becomes at most the preset value, or the number of data to be the subject becomes a maximum determined in advance, determination of whether to transmit with a bandwidth guaranteed can be carried out more strictly.

According to another aspect of the present invention, since the determination unit causes the request unit to carry out a different bandwidth request while measuring the buffer capacity required at that time, and determines whether the packet group is the packet group to be transmitted with the bandwidth guaranteed from the relationship between the requested bandwidth and the required buffer capacity, a bandwidth can be reserved automatically for data transmission even when the transmission condition is not specified by the application.

Further, since the determination unit extracts the maximum value of the buffer capacity required for each requested bandwidth, and determines whether the packet group is the packet group to be transmitted with the bandwidth guaranteed depending upon whether the graph representing the relationship between the requested bandwidth and the maximum value of the required buffer capacity is within a predetermined region, determination of whether to transmit with a bandwidth guaranteed can be readily made.

Further, since the determination unit causes the request unit to request a bandwidth in the predetermined region, and requests the buffer unit to ensure the maximum value of the buffer capacity within the predetermined region, a bandwidth can be requested and buffer capacity ensured according to the medium characteristics and system implementation.

Further, since the determination unit determines the bandwidth to be requested and the buffer capacity to be reserved such that the total cost is minimized based on the cost required to reserve a bandwidth and the cost of the buffer capacity, a bandwidth can be requested and buffer capacity ensured at the optimum level according to the medium characteristics and system implementation.

### BRIEF DESCRIPTION OF THE DRAWINGS

FIG. 1 is a block diagram of a schematic configuration of a transmission device according to a first embodiment of the present invention.

FIG. 2 represents IP packet headers as an example of the packet header.

FIG. 3A represents a process sequentially adding each byte of a header to calculate a hash code.

FIG. 3B represents a process of extracting the low-order 8 bits of the hash code to calculate a flow number.

FIG. 4 represents a pointer array of a flow number basis.

FIG. 5 represents an example of a cell structure having information recorded in the pointer reference destination.

FIG. 6 is a flow chart to describe the process procedure of a flow number calculation unit 102.

FIG. 7 is a flow chart to describe the process procedure of copying cell information stored in a packet information storage unit 103 to a packet information storage unit history 104 at a constant period.

FIG. 8 is a diagram to describe cell delete.

FIG. 9 shows an example of the contents of packet information storage unit history 104.

FIG. 10 is a block diagram to describe in further detail a stream data determination unit 106.

FIG. 11A represents an example of the calculation result of statistics values on a flow basis.

FIG. 11B shows another example of the calculated result of statistics values on a flow basis.

FIG. 12 represents the manner of issuing and accepting a bandwidth request command between a terminal 1 and a bandwidth control device 2.

FIG. 13 shows an example of rules stored in a packet classifier rule storage unit 108.

FIG. 14A shows an example of a network system configuration including the transmission device of the first embodiment of the present invention.

FIG. 14B represents another example of a network system configuration including the transmission device of the first embodiment of the present invention.

FIG. 15 represents a bandwidth allocation method of a general bandwidth control device 2.

FIG. 16 is a diagram to describe the concept when bit rate variation is to be absorbed by a VBR buffer 110.

FIG. 17 represents a flow example when the bit rate varies.

FIG. 18 is a diagram to describe the method of specifying the number of bytes of data output per unit time to calculate how much data remains in the buffer.

FIG. 19 represents the change in the number of bytes of data remaining in the buffer.

FIG. 20 represents the relationship between the requested bandwidth and the required buffer capacity.

FIG. 21 represents an example of the method of extracting the optimum point on a trade-off curve.

### DESCRIPTION OF REFERENCE CHARACTERS

1 transmission device; 2 bandwidth control device; 3 LAN; 4, 5 another network; 6 network; 101 sublayer; 102 flow number calculation unit; 103 flow number-specific packet information storage unit; 104 packet information storage unit; 105 timer; 106 stream data determination unit; 107 bandwidth request command generation unit; 108 packet classifier rule storage unit; 109 packet classifier; 110 VBR buffer; 121 media access controller; 131, 201 MAC management entity; 141 bit rate measurement unit; 142 parameter calculation unit; 143 packet determination unit

### BEST MODES FOR CARRYING OUT THE INVENTION

### First Embodiment

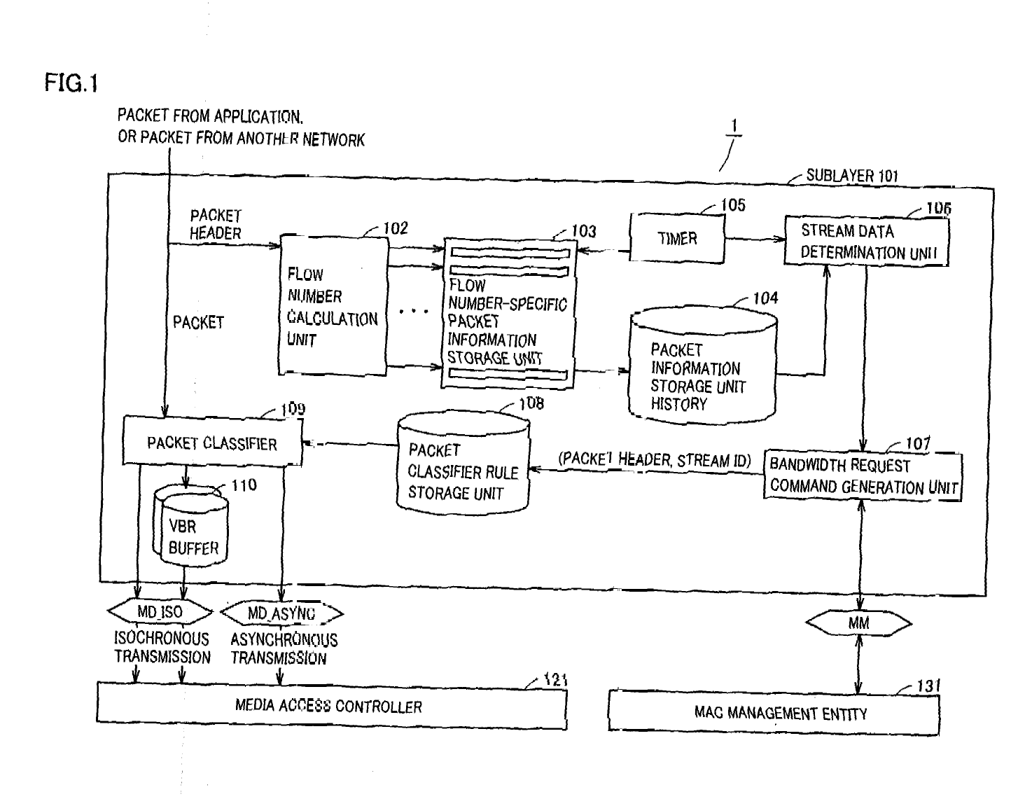

FIG. 1 is a block diagram representing a schematic configuration of a transmission device according to a first embodiment of the present invention. This transmission device 1 includes a sublayer 101 receiving a packet from an application or a packet from a different network to effect overall control of transmission device 1, a media access controller 121 for data transmission and reception via a medium such as radio, and a MAC management entity 131.

Media access controller 121 effects control related to data processing such as beacon transmission and reception, data transmission and reception while looking for the medium empty status, polling response, ACK generation, retransmission control, and the like.

MAC management entity 131 effects control relating to MAC management such as issuing a bandwidth request command to the bandwidth control device, processing a response from the bandwidth control device, administration of the medium unique ID, and the like.

Media access controller 121 and MAC management entity 131 realize the MAC layer function together. They function to provide an interface referred to as SAP (Service Access Point) to an upper layer.

Media access controller 121 provides MD_ISO for synchronous data transmission (MAC Data Isochronous), and MD_ASYNC for asynchronous data transmission (MAC Data Asynchronous). MAC management entity 131 provides the MM (MAC Management) for MAC layer management. Media access controller 121 and MAC management entity 131 are based on a standard such as IEEE 802.11e.

Sublayer 101 is provided at an upper level than media access controller 121 and MAC management entity 131, and includes a flow number calculation unit 102, a flow number-specific packet information storage unit 103, a packet information storage unit history 104, a timer 105, a stream data determination unit 106, a bandwidth request command generation unit 107, a packet classifier rule storage unit 108, a packet classifier 109, and a buffer 110 for VBR. VBR buffer 110 is not used in the present embodiment.

Flow number calculation unit 102 receives a packet from an application or from a different network and extracts the packet header.

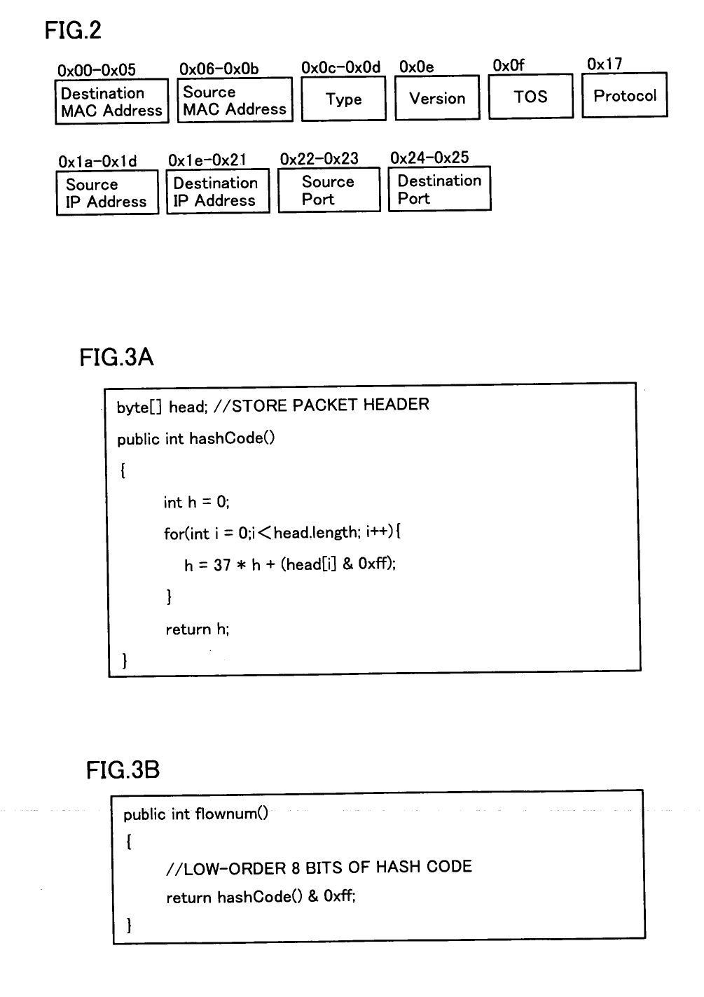

FIG. 2 represents the header of an IP packet as an example of the packet header. The IP packet header includes a destination MAC address, source MAC address, Type Field, Version Field, TOS (priority information of IP level) field, Protocol field, source IP address, destination IP address, source port number, and destination port number.

In the present embodiment, it is assumed that a packet other than an IP packet is ignored. Further, since the protocol takes UDP or TCP as the subject, other packets thereof are also ignored. Since the flow for each application is to be monitored, the UDP/TCP port number is to be included.

Although it is desirable that the packet header includes a field as far as the application can be identified, the header packet does not necessarily have to take the form shown in FIG. 2. Simply, only the Ethernet (registered trademark) address may be taken as the subject. Additionally, the packet may be further analyzed to include, for example, the priority value defined at IEEE 802.1D, the VLAN (Virtual LAN) field defined by IEEE 802.1Q, and the like. The packet header of interest is set appropriately depending upon the type of the packet from an application or from a different network.

Flow number calculation unit 102 calculates a hash code with the packet header as a byte array. A hash code is a value of a fixed length calculated uniquely based on the data. Packet identification can be speeded by comparing the hash code.

FIGS. 3A and 3B show an example of a hash code calculation method. FIG. 3A corresponds to the process of sequentially adding each byte of the header to calculate a hash code. FIG. 3B corresponds to the process of extracting the low-order 8 bits of the hash code calculated by the process of FIG. 3A to obtain the flow number.

Since the hash code obtained by the process of FIG. 3A includes 32 bits, the low-order 8 bits thereof are extracted to be taken as the flow identification number. The packet is classified into 0-255 based on the flow identification number. The flow identification number may be considered as a reduction of the packet header. Although it can be said that a packet having a different flow identification number has a different packet header, the converse thereof is not true. In other words, packets with different packet headers may have the same flow identification number.

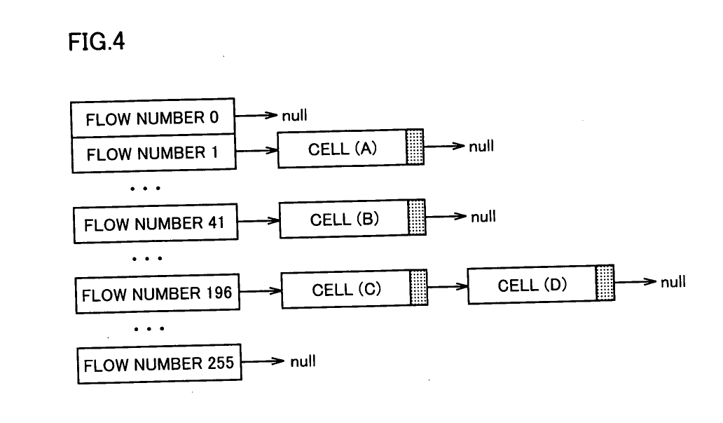

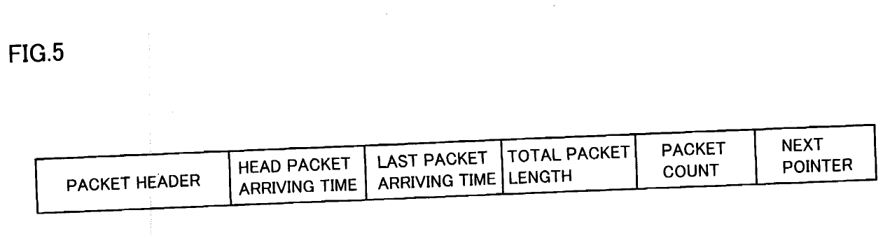

FIG. 4 represents the pointer array on a flow number basis. Flow number calculation unit 102 has 256 pointers based on the flow identification number. The initial value of all the pointers is null. A pointer with a “null” reference destination implies that the packet corresponding to that flow identification number has not yet arrived. If the pointer reference destination is not null, the packet corresponding to that flow identification number has arrived.

Information such as the packet header is recorded in the pointer reference destination, as will be described afterwards. The information is organized on a cell-by-cell basis. For example, the packet corresponding to flow identification number 0 has not yet arrived in FIG. 4. Only one packet corresponding to flow identification number 1 has arrived, and information thereof is recorded in cell (A). Two packets corresponding to flow identification number 196 has arrived, and information thereof is recorded in cell (C) and cell (D), respectively.

FIG. 5 shows an example of a cell structure having information recorded at the pointer reference destination. The cell structure includes a packet header, the head packet arriving time, the last packet arriving time, the total packet length, the number of packets, and the next pointer. The next pointer is included to allow packets of different packet headers to be processed in distinction from each other by tracing the next pointer even when packets with different packet headers have the same flow identification number. The initial value of the next pointer is null. A next pointer with “null” indicates that there is no packet with the same flow identification number and a different packet header. When the next pointer is not “null”, there is another packet having the same flow identification number and different packet header. The initial values of the total packet length and the packet count are 0.

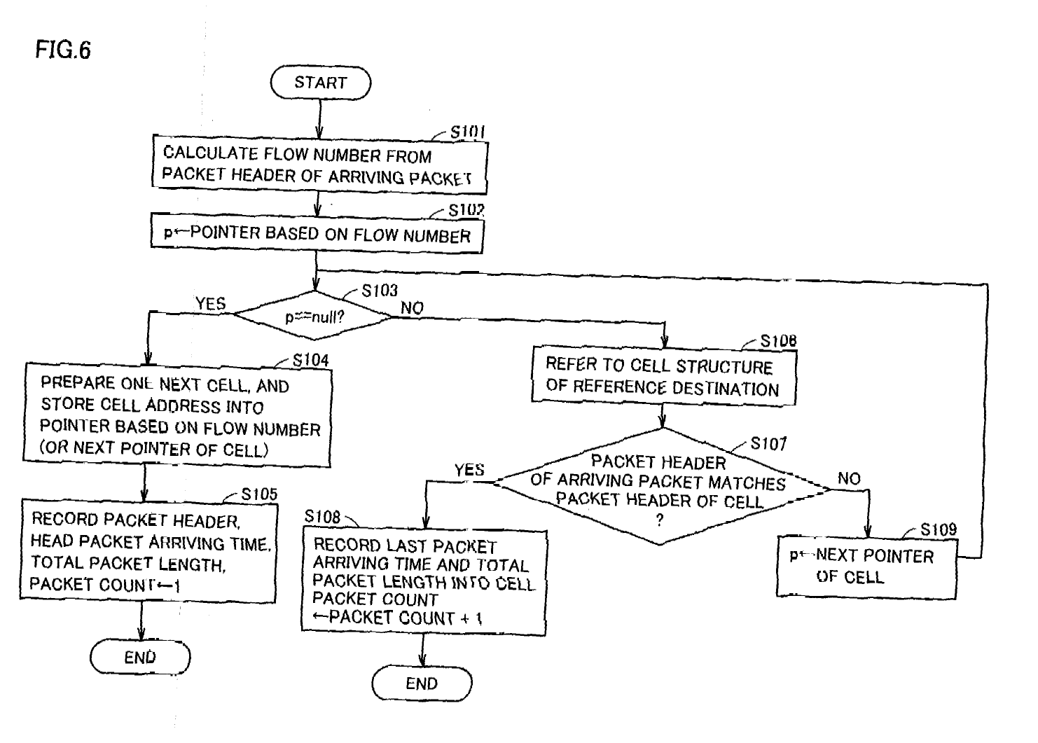

FIG. 6 is a flow chart to describe the process procedure of flow number calculation unit 102. When a packet arrives, flow number calculation unit 102 calculates the flow identification number from the packet header through the process of FIGS. 3A and 3B (S101). Then, the flow identification number-specific pointer is substituted to “p” (S102).

Then, flow number calculation unit 102 determines whether “p” is “null” or not (S103). When “p” is null (S103, Yes), one new cell is prepared, and the address of that cell is stored in the flow identification number-specific pointer or in the next pointer of the cell (when control proceeds from S109). Then, the packet header of the arriving packet, the head packet arriving time, the total packet length are recorded in the cell, and 1 is substituted to the packet count (S105). Thus, the process ends.

When “p” is not null (S103, No), flow number calculation unit 102 obtains the information of the cell referenced by “p” (S106). Determination is made whether the packet header of the arrived packet matches the packet header of the cell (S107). When the packet headers match (S107, Yes), the last packet arriving time and total packet length are recorded in that cell, and the packet count is incremented (S108). Thus, the process ends.

When the packet headers do not match (S107, No), the next pointer of the cell is substituted to “p” (S109), and control returns to step S103.

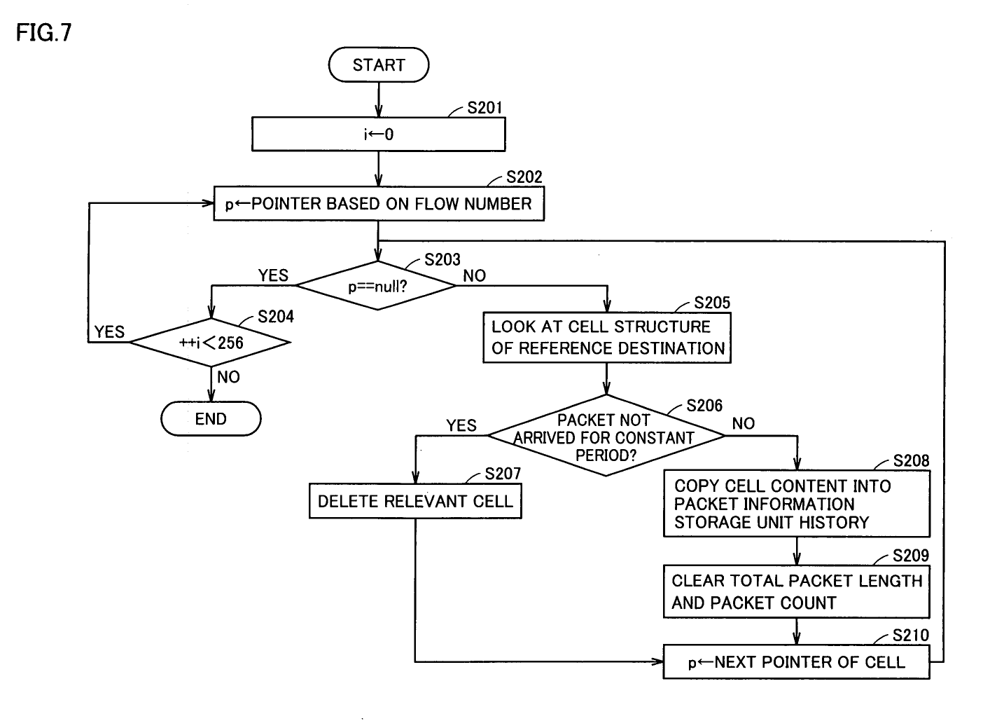

FIG. 7 is a flow chart to describe the procedure of copying the information of the cell stored in packet information storage unit 103 to packet information storage unit history 104. It is assumed that this process is executed by packet information storage unit 103 at every elapse of a predetermined time measured by timer 105.

Packet information storage unit 103 substitutes 0 to the variable i (S201). The pointer of flow number i is substituted to “p” (S202). Determination is made whether “p” is null or not (S203).

When “p” is null (S203, Yes), variable i is incremented. If the incremented value is smaller than 256 (S204, Yes), control returns to step S202 to repeat the following process. When the increment value is 256 or above (S204, No), the process ends.

When “p” is not null (S203, No), the information of the cell referred to by “p” is extracted (S205). Then determination is made whether the packet of the referenced cell has not arrived for a constant period (S206). This determination of whether the packet has not arrived for a constant period is made based on the last packet arriving time and current time. When a packet has not arrived for a constant period (S206, Yes), that cell is deleted (S207).

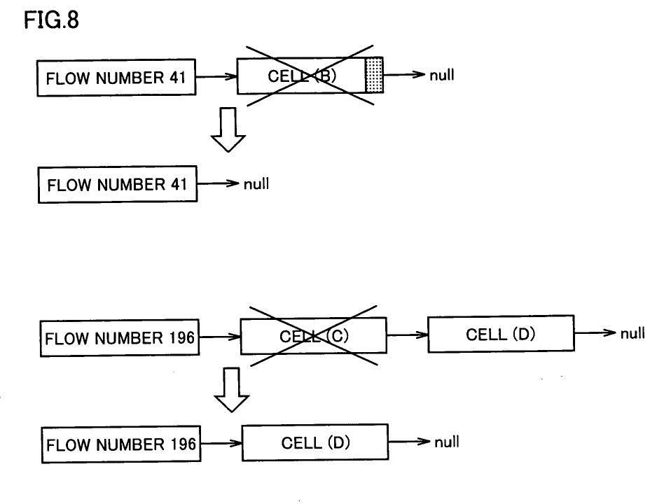

FIG. 8 is a diagram to describe cell delete. Since the cell corresponding to flow number 41 is only cell (B), the pointer of flow number 41 is set to null when cell (B) is to be deleted. Since the cells corresponding to flow number 196 are cell (C) and cell (D), the pointer reference destination of flow number 196 is set to cell (D) when cell (C) is to be deleted. Thus, the pointer reference destination referring to the deleted cell (the flow number-specific pointer and the like) is set to the next pointer of the deleted cell. If the last packet arriving time is not updated for at least a constant period, that cell is deleted on the assumption that the relevant flow no longer exists. The deleted cell is used again afterwards.

If a packet has arrived within a constant period (S206, No), the content of the referenced cell is copied into packet information storage unit history 104 (S208). It is assumed that there is a sufficient amount of memory to store the bit rate for a long time for all the flows in packet information storage unit history 104.

Packet information storage unit 103 clears the total packet length and packet count in the cell (S209). The next pointer of the cell is substituted to “p” (S210). Then, control returns to S203 to repeat the following process.

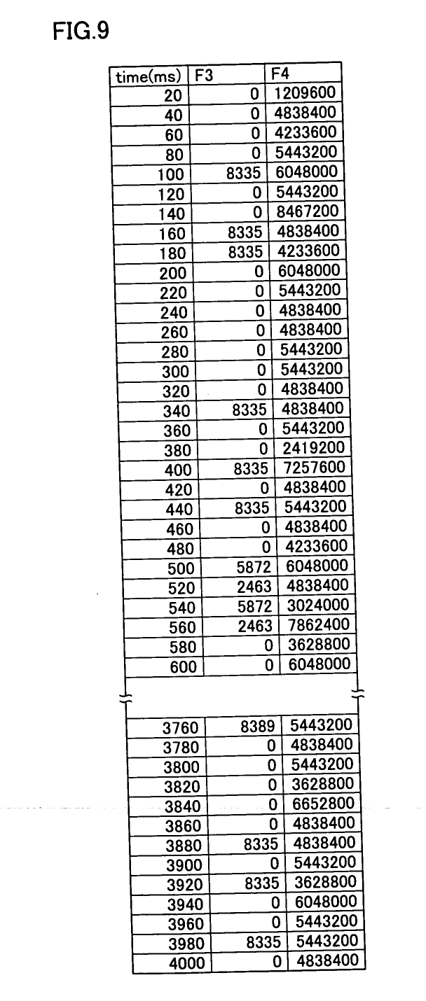

FIG. 9 shows an example of the contents of packet information storage unit history 104. In the present embodiment, the latest data of 400 ms is taken as the subject of calculation. FIG. 9 shows a portion thereof. F3 and F4 represent flows classified according to the packet header. The total packet length (number of bytes) per unit time (20 ms) is sequentially stored. The interval activated by timer 105 is made to comply with the MAC beacon period.

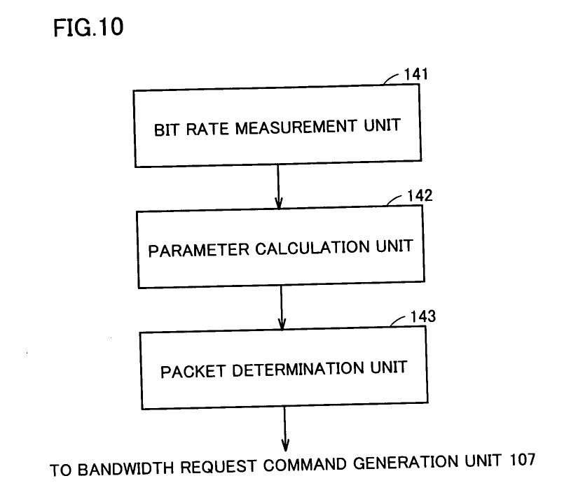

FIG. 10 is a block diagram to describe in further detail stream data determination unit 106. Stream data determination unit 106 includes a bit rate measurement unit 141, a parameter calculation unit 142, and a packet determination unit 143.

Bit rate measurement unit 141 reads out the latest predetermined number of data (total packet length per unit time) from packet information storage unit history 104 to measure the bit rate per unit time. Parameter calculation unit 142 calculates the statistics value (parameter) from the bit rate per unit time obtained by bit rate measurement unit 141. The statistics value includes an average m(x), standard deviation σ(x), and a coefficient of variation ν that is the standard deviation divided by the average, as shown in equations (1)-(3). It is known that the coefficient of variation ν becomes a relative standard deviation independent of the magnitude of the average of the population. In order to identify the variation in the flow rate, a coefficient of variation that does not depend upon the magnitude of the flow rate should be used. A smaller coefficient of variation v indicates that variation is small, whereas a larger coefficient of variation v indicates a larger variation.

$$\begin{matrix}m ( x ) = \frac{1}{n} {\sum }_{i = 1}^{n} {x}_{i} & ( 1 ) \\ σ ( x ) = \sqrt{\frac{1}{2} {\sum }_{i = 1}^{n} {\{ {x}_{i} - m ( x ) \}}^{2}} & ( 2 ) \\ v = \frac{σ ( x )}{m ( x )} & ( 3 )\end{matrix}$$

Packet determination unit 143 determines that the flow corresponds to stream data when the coefficient of variation is equal to or below a set value. For example, determination is made that the flow corresponds to stream data when the coefficient of variation is at most 0.3. The threshold to be compared with the coefficient of variation should be allowed to be set as a parameter.

When the coefficient of variation is larger than the preset value, bit rate measurement unit 141 may increase the number of data to be taken from packet information storage unit history 104 (total packet length per unit time) and recalculate the coefficient of variation.

Further, when the coefficient of variation is larger than a preset value, bit rate measurement unit 141 may repeat the calculation for a coefficient of variation while sequentially increasing the number of data (total packet length per unit time) to be extracted from packet information storage unit history 104. In this case, calculation is repeated until the number of data to be extracted becomes a maximum that is determined in advance, and determination is made that the flow does not correspond to stream data if the coefficient of variation is higher than the preset value.

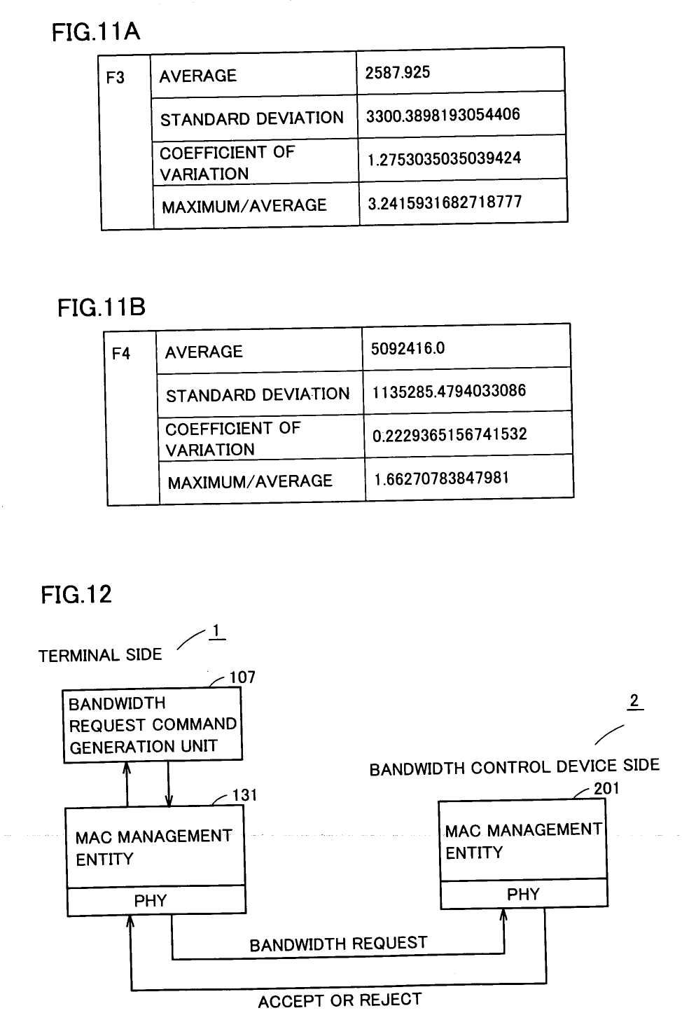

FIGS. 11A and 11B show an example of the calculated result of the statistics value on a flow basis. The flow of F3 shown in FIG. 11A has great variation with the coefficient of variation exceeding 1. Therefore, determination is made that F3 is not stream data. The flow of F4 shown in FIG. 11B has a coefficient of variation of approximately 0.2. It is appreciated that the variation is small. Therefore, determination is made that F4 is stream data.

Parameter calculation unit 142 may be configured to also calculate the maximum value/average value. This value indicates how much the peak rate is away from the average value. When the peak rate becomes extremely large temporarily, transmission cannot be conducted properly even if a bandwidth is ensured. Therefore, the maximum value/average value is calculated to confirm that the value thereof is not too large.

When determination is made that the flow is stream data, packet determination unit 143 determines the QoS parameter, and notify bandwidth request command generation unit 107 of the parameter.

Bandwidth request command generation unit 107 issues a bandwidth request command to the bandwidth control device via MAC management entity 131. At this stage, the requested QoS parameter can be specified. The minimum value/average value/maximum value of the requested bandwidth, the frame size average value, the longest delay time, jitter, and the like are specified for the QoS parameters. Specification is made as set forth below.

The average value of the measured bit rate, or the medium or mode that is a more robust representative is taken as the minimum value of the requested bandwidth. The average value of the requested bandwidth corresponds to an addition of a proportionate of standard deviation σ with the average of the measured bit rate as the base. In other words, (average+k1*σ) is employed.

The maximum value of the measured bit rate, or an addition of a proportionate of standard deviation σ with the average of the measured bit rate as the base is taken as the maximum value of the requested bandwidth. In other words, (average+k2*σ) is taken, provided that k1<k2. The method of calculating the requested bandwidth is only a way of example, and calculation can be conducted with a combination of other statistics values. The average of the frame size is calculated by dividing the measured total packet length by the number of packets.

The allowed longest delay time and jitter allowed in the delay time cannot be set unless the packet type is identified. In the present embodiment, the process set forth below is carried out optionally.

The longest delay time is determined in advance such as the longest delay time of 300 ms, 10 ms, and 100 ms when the packet type corresponds to an AV stream, VoIP, and audio stream, respectively. If it is known that the packet is an RTP packet, the type of packet can be identified by looking at the RTP payload type.

Determination of whether the packet is an RTP packet or not can be made by looking at the regularity of the RTP header. The RTP payload type and application mapping are defined by RFC1890. For example, when payload type=0, the type definition is ITU-T G.711, and identification can be made that the packet type is VoIP. If the packet type is identified, the maximum delay time as determined above can be set.

Even if the packet is not an RTP packet, the packet type can be predicted by the packet arriving interval, packet length, and the like. For example, when the packet arriving interval is 20 ms, and the packet length is fixed at approximately 200 bytes, it can be predicted that the packet is VoIP. Thus, based on the packet protocol identification, or the packet arriving interval to estimate the packet type, the maximum delay time of as determined above can be specified. However, the packet type may not always be identified, and the maximum delay time and/or jitter parameter is not set if the packet type cannot be identified.

FIG. 12 represents the manner of issuing and accepting a bandwidth request command between terminal 1 and bandwidth control device 2. Bandwidth request command generation unit 107 specifies the QoS parameter, and issues a bandwidth request command to bandwidth control device 2 via MAC management entity 131.

Upon receiving a bandwidth request command via MAC management entity 201, bandwidth control device 2 refers to the current bandwidth allocation state to determine whether the new bandwidth request command is acceptable or not. MAC management entity 131 is notified of whether the command is acceptable or not. At this stage, the stream ID is informed by bandwidth control device 2. When acceptable, MAC management entity 131 notifies bandwidth request command generation unit 107 accordingly.

When bandwidth request command generation unit 107 is notified of the acceptable state by MAC management entity 131 and receives a stream ID, bandwidth request command generation unit 107 stores the set of the packet header and stream ID in packet classifier rule storage unit 108.

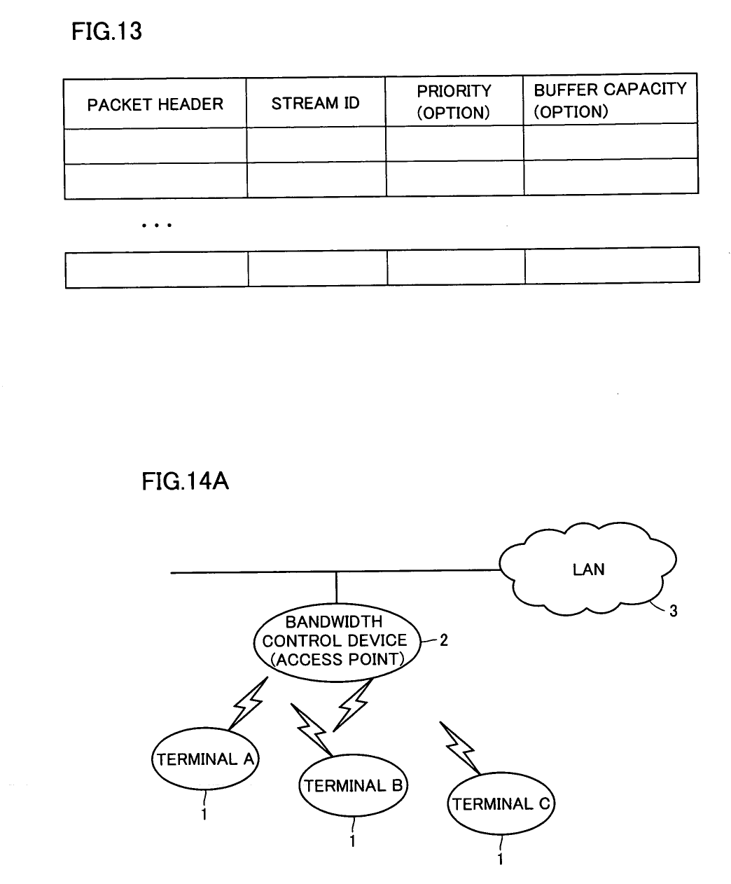

FIG. 13 shows an example of rules stored in packet classifier rule storage unit 108. The packet header and stream ID set is at least stored in packet classifier storage unit 108. In a more general-purpose manner, the priority and buffer capacity may be stored. These are options. The priority affects the order in which the rule is applied. Further, the buffer capacity indicates the capacity of VBR buffer 110 that is required by that flow.

The rule stored in packet classifier rule storage unit 108 includes, in addition to those stored by bandwidth request command generation unit 107, those implicitly produced in sublayer 101, or explicitly specified from an upper layer.

Packet classifier 109 classifies a packet based on the rule stored in packet classifier rule storage unit 108. Packet classifier 109 sequentially applies the rule stored in packet classifier rule storage unit 108 at every arrival of a packet, and determines that the packet corresponds to stream data when the packet header matches the rule condition.

When the packet corresponds to stream data, packet classifier 109 transmits the data via MD_ISO (isochronous transmission). If the packet does not correspond to stream data, packet classifier 109 transmits the data via MD_ASYNC (asynchronous transmission).

Packet classifier 109 may carry out the process of adding the stream ID at the head of the packet header since the stream ID is stored in packet classifier rule storage unit 108. Addition of a stream ID in the packet header will allow the circuit configuration of media access controller 121 to be simplified since media access controller 121 can easily classify a packet by referring to the stream ID thereof. Otherwise, media access controller 121 must refer to the packet header again to classify a packet.

Upon detecting that the flow no longer exists, stream data determination unit 106 notifies bandwidth request command generation unit 107 to issue a bandwidth release request command. Detection of whether there is no longer a flow can be made by the fact that no information comes from flow number-specific packet information storage unit 103.

Bandwidth request command generation unit 107 issues a bandwidth release request command to bandwidth control device 2 via MAC management entity 131. Bandwidth control device 2 receives the bandwidth release request command, and notifies MAC management entity 131 the stream ID of the released bandwidth. Upon receiving the stream ID of the released bandwidth, bandwidth request command generation unit 107 deletes the set of packet header and stream ID stored in packet classifier rule storage unit 108.

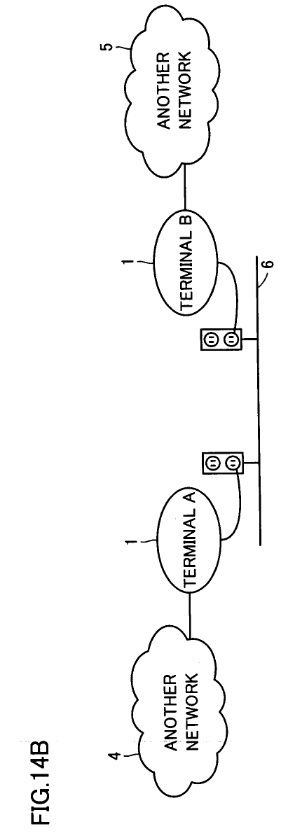

FIGS. 14A and 14B show examples of a network system configuration including the transmission device according to the first embodiment of the present invention. FIG. 14A represents a general configuration in a wireless LAN infrastructure mode. The transmission device of the present embodiment is included in terminals A-C, connected on a LAN 3. Bandwidth control device 2 often serves as the wireless LAN access point.

FIG. 14B represents a configuration in which the transmission device of the present embodiment is employed as ad hoc mode in a wireless LAN or a bridge between other networks 4 and 5. Any one of terminals A and B connected on network 6 becomes bandwidth control device 2. On the network, there is only one bandwidth control device 2. Bandwidth control device 2 is determined in advance, or determined dynamically.

In the present embodiment, a network supporting QoS is of interest. In the field where the network medium is wireless, IEEE 802.11e, UWB (Ultra Wide Bandwidth), Hi-SWAN, wireless 1394, and the like are known. When the medium is wired, the medium includes a twist pair cable, electric power line, coaxial cable, optical fiber, or the like, and corresponds to a network that supports QoS.

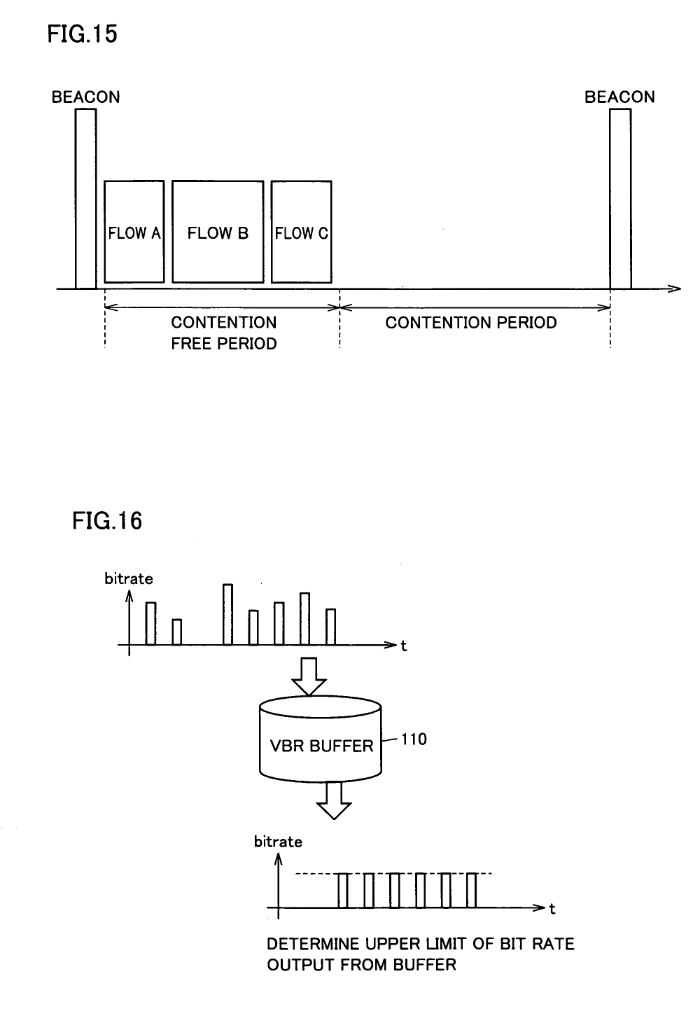

FIG. 15 represents the bandwidth allocation method of a general bandwidth control device 2. Bandwidth control device 2 accurately dispatches a beacon at a constant interval. The beacon interval time depends upon the medium and implementation, and is generally approximately 5 ms to 100 ms. Bandwidth control device 2 divides the beacon interval into a contention free period and contention period. Data that is to be transmitted with a bandwidth reserved is transmitted in a contention free period.

In FIG. 15, flow A, flow Bandwidth flow C are transmitted in a contention free period. In a contention free period, the timing of transmission by each terminal is determined, so that collision will not occur. The contention period corresponds to the scheme in which the transmitting terminal conducts carrier sensing and waits for a period of time equal to random backoff. Therefore, there is a possibility of collision occurring if the random backoff time matches between two or more terminals.

In accordance with the transmission device of the present embodiment, stream data determination unit 106 generates, when determination is made that the flow corresponds to stream data, the QoS parameter based on the measured bit rate, and causes bandwidth request command generation unit 107 to issue a bandwidth request command. Therefore, the optimum QoS parameter can be generated automatically to allow a bandwidth to be reserved even in the case where there is no specification of a transmission condition by the application.

When determination is made that the flow corresponds to stream data by stream data determination unit 106, data will be transmitted during the contention free period, allowing the media usage efficiency to be improved.

Not only an application that requires real-time characteristics such as stream data, but also a general application that has a fixed bandwidth, can reserve a bandwidth for transmission. Therefore, the media usage efficiency can be further improved.

### Second Embodiment

Although the transmission device described in the first embodiment of the present invention is valid for an application with a fixed bit rate, there are cases where the device is not valid for applications with a variable bit rate. The transmission device according to the second embodiment of the present invention is applicable to an application with a variable bit rate.

The transmission device according to the second embodiment of the present invention differs from the transmission device of the first embodiment in that a buffer 110 for VBR is added and the function of stream data determination unit 106 differs. Therefore, details of similar configuration and function will not be repeated. The stream data determination unit in the present embodiment is designated as reference number 106′.

FIG. 16 is a diagram to describe the concept of absorbing bit rate variation by VBR buffer 110. As shown in FIG. 16, even when the bit rate of the packet from an application input to sublayer 101 or a packet on the transmission path varies over time, bit rate variation can be absorbed at VBR buffer 110 by packet classifier 110 defining an appropriate upper limit for the rate of the bits flowing on the transmission path for packet transmission control. Even if the bit rate rises temporarily, any packet not transmitted can be stored in VBR buffer 110. Thus, the rate of bits flowing through the transmission path can be adjusted.

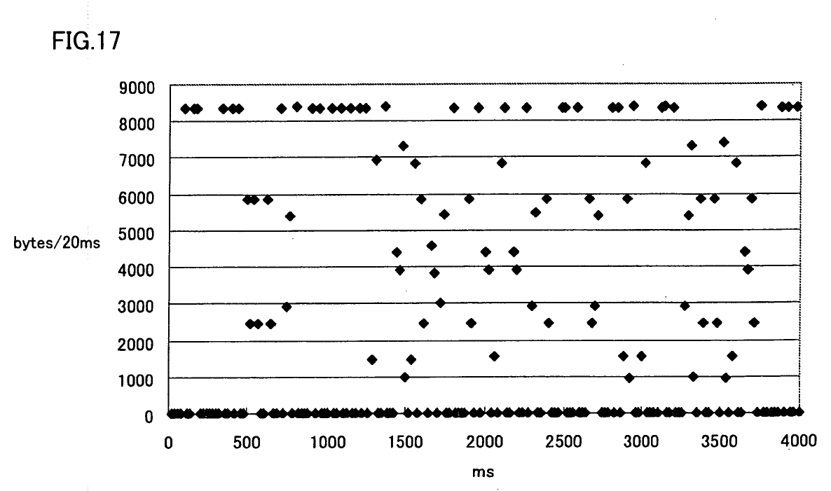

FIG. 17 shows an example of a flow when the bit rate varies. By calculating the coefficient of variation according to the method described in the first embodiment, determination of stream data will not be made since the coefficient of variation exceeds 1.

Instead of calculating the variation degree as described in the first embodiment, stream data determination unit 106′ obtains the relationship between the requested bandwidth and the required buffer capacity based on the absorption of the bit rate variation at VBR buffer 110. In other words, simulation of the required buffer capacity based on the requested bandwidth is preformed.

First, stream data determination unit 106′ obtains the average of the total packet length for the latest specified period of time (for example, for 1000 ms). The number of bytes output per unit time (cout) is provisionally determined to calculate the required buffer capacity. The number of bytes output per unit time is to be a value slightly larger than the average of the total packet length (cout=average×α, α>1.0).

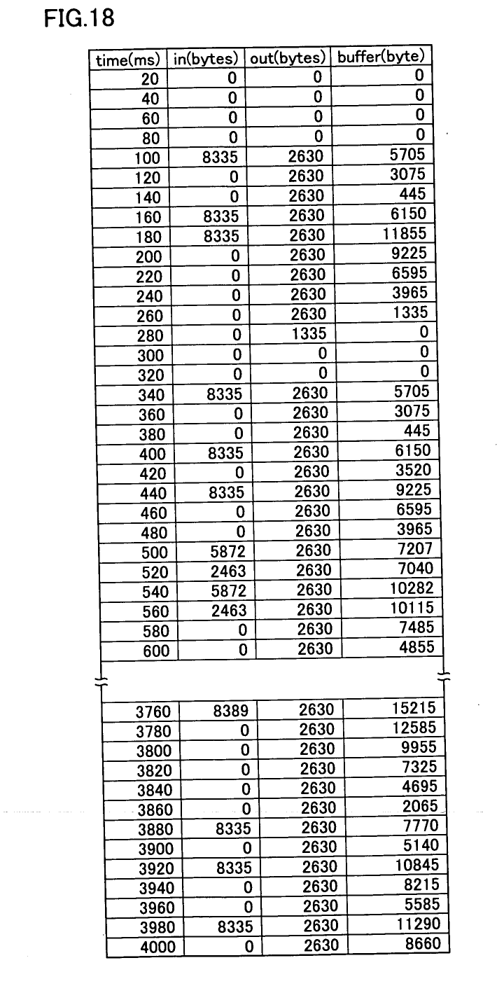

FIG. 18 is a diagram to describe the method of specifying the number of bytes of data output per unit time to calculate the remaining data (number of bytes) in the buffer.

FIG. 18 represents only a portion thereof. In FIG. 18, “time” represents an elapse from a certain point in time, and takes an interval of 20 ms. “In” indicates the number of bytes (Aₙ) of data input into the buffer per unit time. “Out” indicates the number of bytes (Bₙ) of data output from the buffer per unit time. “Buffer” represents the number of bytes (Cₙ) of data remaining in the buffer.

If Aₙ is the number of bytes of data input per unit time (actual measured result), Bₙ is the number of bytes of data output per unit time, and Cₙ is the number of bytes of data remaining in the buffer, Bₙ and Cₙ can be obtained by the following equations. The subscript n indicates the elapse count per unit time.

Bₙ=MIN(Cₙ₋₁+Aₙ,cout) (4)

Cₙ=Cₙ₋₁+Aₙ−Bₙ(Cₒ=0) (5)

The average is the average of Aₙ. Bₙ and Cₙ are calculated with “cout” provisionally determined as a value slightly larger than the average.

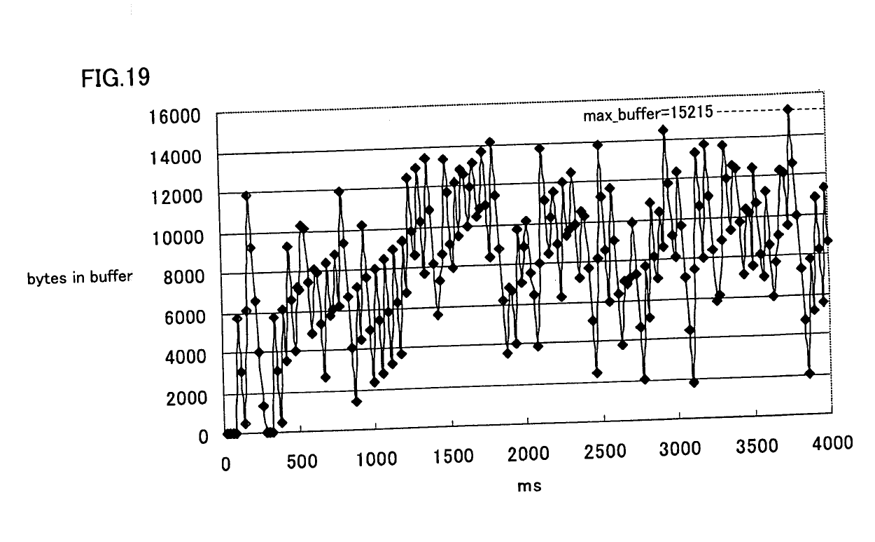

FIG. 19 represents the change in the number of bytes (Cₙ) of data remaining in the buffer. It is appreciated from FIG. 19 that the number of bytes of data remaining in the buffer is settled within a certain range. The required buffer capacity is determined by the maximum value of the number of bytes of data remaining in the buffer (max_buffer).

In FIG. 19, average=2588 is established. Upon a calculation with cout=2630 provisionally defined, cout/average=1.016258, max_buffer=15215, and max_buffer/average=5.879228 are established.

Stream data determination unit 106′ alters the number of bytes (cout) output per unit time and repeats the calculation set forth above. By sequentially altering the number of bytes output per unit time (the bandwidth to be requested to the bandwidth control device), the change in the maximum value of the number of bytes of data remaining in the buffer (the required buffer capacity) can be identified.

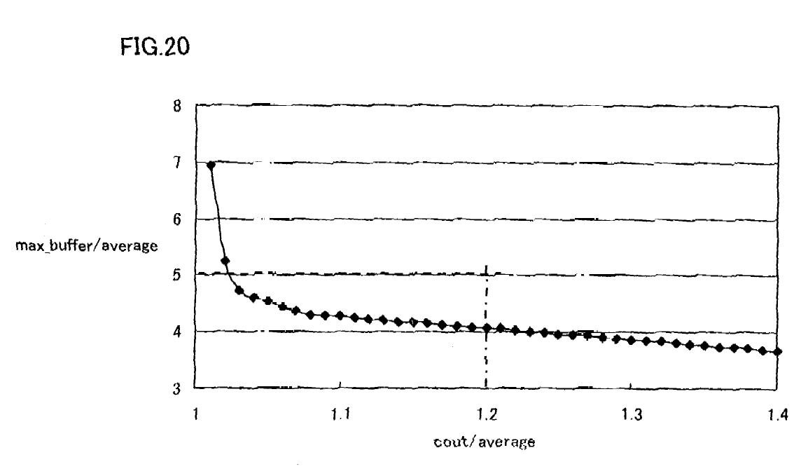

FIG. 20 represents the relationship between the requested bandwidth and the required buffer capacity. It is appreciated from FIG. 20 that there is a trade-off between the requested bandwidth and required buffer capacity. FIG. 20 represents the value of β (max_buffer/average) when α(=cout/average) is varied from 1.01 to 1.40 in the steps of 0.01. It is appreciated that the relationship between cout/average and max_buffer/average substantially establishes an inverse proportional relationship. As a result of the simulation, it was found that this trade-off relationship is realized for various flows.

Since cout/average and max_buffer/average take substantially an inverse proportional relationship, the calculation set forth above does not have to be carried out many times. For example, a method of calculating only two points for α and interpolate the others may be employed. For example, the calculation set forth above is carried out for only α=1.1 and α=1.3, for example. Then, the product of cout/average and max_buffer/average is calculated, and an average thereof is obtained. The value of max_buffer/average when α is altered can be estimated by the product average/α. This interpolation method is advantageous since the calculation set forth above, if carried out in practice, is repetitive and time consuming.

Based on the trade-off curve of FIG. 20, determination is made whether the data is to be transmitted with a bandwidth guaranteed. For the determination criterion, two elements must be taken into account.

The first is the upper limit of the requested bandwidth. In view of improving the media usage efficiency by transmission with a bandwidth guaranteed, there is no point in requesting a bandwidth that is excessive as compared to the average of the bit rate. The usage efficiency of the medium must not be deteriorated by a transmission with a bandwidth guaranteed. Therefore, the upper limit of cout/average will be determined inherently. It is considered that this depends upon the media transmission scheme and/or implementation of the media access controller. In the present embodiment, the upper limit of cout/average is set to 1.2 (the chain dotted line in FIG. 20).

The second element is the problem between the buffer capacity and delay. Storing the data in a buffer and conducting transmission means that corresponding delay will occur. Max_buffer/average×unit time represents the longest delay time that the buffer has to wait. Therefore, the longest delay time must be set to an appropriate time. In the present embodiment, the longest delay time is set to 100 ms. Since the unit time is 20 ms, the upper limit of max_buffer/average is set as 5.0 (dotted line in FIG. 20). It is also necessary to confirm whether the buffer capacity can be actually ensured. The buffer capacity is provided by max_buffer.

These two upper limits are overlaid on the trade-off curve. In FIG. 20, the upper limit of cout/average is indicated by the chain dotted line whereas the upper limit of max_buffer/average is indicated by the dotted line. When the trade-off curve is present in the region surrounded by the chain dotted line and dotted line, i.e. when the constraint of the two upper limits are both satisfied, determination is made that the data is to be transmitted with a bandwidth guaranteed. In practice, cout is set up to the upper limit, and max_buffer is calculated. If max_buffer exceeds the upper limit, determination is made that it does not correspond to stream data. If max_buffer is within the upper limit, determination is made that it corresponds to stream data, and a trade-off curve is calculated in order to identify the optimum point.

In the case of general stream data, the trade-off curve settles in an appropriate range for both the vertical axis and horizontal axis, as shown in FIG. 20. When a trade-off curve for a traffic with burst characteristics is drawn, the curve will not settle in an appropriate range for the vertical axis or the horizontal axis (for example, max_buffer/average exceeds 100, or the like). Although the above-described facts will become apparent upon simulation, they can be readily understood from desk-top paper planning.

When determination is made of data to be transmitted with a bandwidth guaranteed, any one point that satisfies both the two constraints of the upper limit is extracted, and the required buffer capacity is calculated. It is assumed that the required buffer capacity is a multiplication of max_buffer by a proportional constant k (k>1).

Stream data determination unit 106′ requests packet classifier 109 to ensure the required buffer capacity. When packet classifier 109 succeeds in ensuring the required buffer capacity, stream data determination unit 106′ instructs bandwidth request command generation unit 107 to request a bandwidth.

Bandwidth request command generation unit 107 issues a bandwidth request command to bandwidth control device 2. Upon receiving an acceptable message from bandwidth control device 2, bandwidth request command generation unit 107 notifies packet classifier rule storage unit 108 of the packet header and stream ID together with the buffer capacity required by the flow. The buffer capacity is for VBR buffer 110.

Packet classifier 109 sequentially applies the rule stored in packet classifier rule storage unit 108 for every arrival of a packet. When the packet header matches the condition, determination is made of stream data, and data is transmitted via MD_ISO (isochronous transmission). If the buffer capacity is specified, the bit rate of data flowing through the transmission path is adjusted via VBR buffer 110.

Which of the points simultaneously satisfying the two constraints of the upper limit on the trade-off curve is to be selected will be described hereinafter.

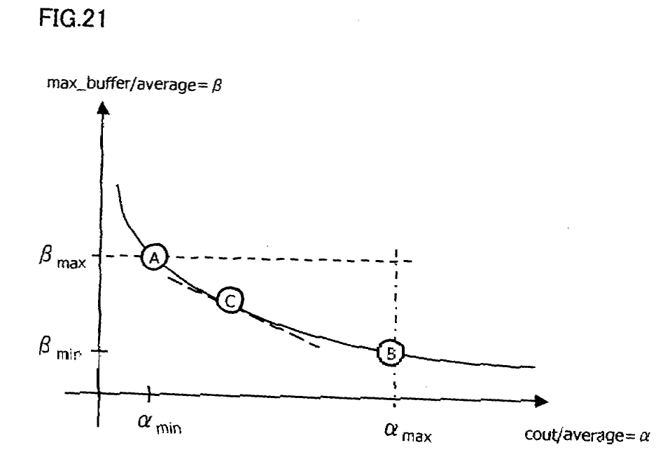

FIG. 21 shows an example of a method of extracting the optimum point on the trade-off curve. There are three possible methods for extraction. If importance is given to reduce the required bandwidth, A in FIG. 21 becomes the optimum point.

If importance is given to minimize the buffer capacity (reduce delay), B in FIG. 21 becomes the optimum point.

Minimizing the total cost may also be given importance. Let Cₙ be the cost of the bandwidth of the transmission path, and C_{α} the cost of the buffer capacity (delay). The point where C_{α}·α+C_{β}·β is smallest is selected. When the cost of the bandwidth in the transmission path is considerably higher than the cost of the buffer capacity (delay) (when C_{α}>>C_{β}), A of FIG. 21 becomes the optimum point.

When the cost of the buffer capacity (delay) is considerably higher than the cost of the bandwidth in the transmission path (when C_{β}>>C_{α}), B in FIG. 21 becomes the optimum point. In other cases, C in FIG. 21 becomes the optimum point. By obtaining the point where the line of inclination—C_{α}/C_{β} comes into contact with the trade-off curve, the optimum point can be obtained.

Which is to be given priority depends upon the medium characteristics and/or system implementation. Therefore, adjustment of the optimum point should be allowed. The two upper limits, i.e. the upper limits of the requested bandwidth and the buffer capacity (the upper limit of delay) are to be applied as parameters. Further, the cost coefficient is to be applied as a parameter.

The term “cost” used herein is introduced as a notional term, and is not limited to the meaning of “cost” generally used. It should be used to select the optimum point in the trade-off relationship between the requested bandwidth and buffer capacity (delay).

In accordance with the transmission device of the present embodiment set forth above, variation in the bit rate of data is absorbed by VBR buffer 110, and stream data determination unit 106′ determines whether the data is to be transmitted with a bandwidth guaranteed from the relationship between the requested bandwidth and the required buffer capacity. Therefore, a bandwidth can be reserved, as necessary, even when the transmission condition is not specified by the application.

Since the requested bandwidth and required buffer capacity are determined based on the bandwidth cost of the transmission path and buffer capacity cost, the bandwidth request and the required buffer capacity can be ensured such that the total cost is minimized.

In light of the description of embodiments of the present invention set forth above, it is assumed that measurement of the bit rate of the relevant packet group is continued even after transmission is initiated with the bandwidth guaranteed, and calculation required for determination of stream data is continued by stream data determination unit 106 of the first embodiment and stream data determination unit 106′ of the second embodiment. Whether the characteristics of the bit rate of the relevant packet group has changed or not is confirmed, and an appropriate process is carried out when the characteristics has changed. There are three possible cases as set forth below.

The first is the case where the relevant packet group is no longer observed for a predetermined time. Stream data determination unit 106 (106′) notifies bandwidth request command generation unit 107 to release the bandwidth guaranteed for the relevant packet group. Upon receiving a bandwidth release notification, bandwidth request command generation unit 104 deletes the set of the packet header and stream ID of the relevant packet group from packet classifier rule storage unit 108. Then, a bandwidth release command is issued to the bandwidth control device via MAC management entity 131, and response therefrom is received. It is expected that a response of the bandwidth release command is always a success.

The second corresponds to the case where the characteristics of the bit rate of the relevant packet group varies, and stream data determination unit 106 (106′) determines that the relevant packet group still corresponds to stream data. Stream data determination unit 106 (106′) determines whether bandwidth change is required or not, and generates the QoS parameter when determination is made that bandwidth change is required. Bandwidth request command generation unit 107 is requested to modify the bandwidth guaranteed for the relevant packet group to the latest value. Bandwidth change is required in the case where, for example, the average of the bit rate measured for the latest bit rate measurement unit time is at least 10% greater than the bit rate of the currently used bandwidth. Upon receiving a bandwidth change notification, bandwidth request command generation unit 107 issues a bandwidth change command to the bandwidth control device via MAC management entity 131, and receives a response thereof. If the response of the bandwidth change command indicates success, isochronous transmission is continued. If the response of the bandwidth change command indicates failure, stream data determination unit 106 (106′) determines that isochronous transmission cannot be continued, and notifies bandwidth request command generation unit 107 to release the bandwidth guaranteed for the relevant packet group. The process thereafter is as described before. Stream data determination unit 106 (106′) continues isochronous transmission when determination is made that bandwidth change is not required.

The third corresponds to the case where the characteristics of the bit rate of the relevant packet group varies, and stream data determination unit 106 (106′) determines that the relevant packet group does not correspond to stream data any more. The determination of not corresponding to stream data may be based on the method described in the first and second embodiments. Further, the subsequent stream data determination method may be adjusted for the packet group initiated in transmission with the bandwidth guaranteed. For example, the threshold value of the coefficient of variation may be adjusted in the first embodiment. When determination is made that the relevant packet group no longer corresponds to stream data, stream data determination unit 106 (106′) notifies bandwidth request command generation unit 107 to release the bandwidth guaranteed for the relevant packet group. The process thereafter is as described before.

It should be understood that the embodiments disclosed herein are illustrative and non-restrictive in every respect. The scope of the present invention is defined by the terms of the claims, rather than description above, and is intended to include any modifications within the scope and meaning equivalent to the terms of the claims.

1. A transmission device conducting communication with predetermined quality ensured, comprising:
a classification unit classifying a packet of data to be transmitted according to each packet header,
a determination unit organizing a set of packets having the same packet header as a packet group according to a classified result by said classification unit, and determining whether to be transmitted with a bandwidth guaranteed according to a bit rate of the packet group, and
a request unit requesting a bandwidth control device to reserve a bandwidth for a packet group determined to be transmitted with a bandwidth guaranteed by said determination unit.

2. The transmission device according to claim 1, wherein said determination unit comprises
a measurement unit measuring the bit rate per predetermined unit time of said packet group,
a calculation unit calculating a parameter representing variation in the bit rate with a latest predetermined number of data to be a subject from a measured result by said measurement unit, and
a packet determination unit determining that the packet group is a packet group to be transmitted with a bandwidth guaranteed when the parameter calculated by said calculation unit is at most a preset value.

3. The transmission device according to claim 2, wherein
said calculation unit increases the number of data to be the subject of calculation when the calculated parameter is larger than a preset value and recalculates the parameter, and
said packet determination unit determines that the packet group is the packet group to be transmitted with a bandwidth guaranteed when a value of said recalculated parameter is at most the preset value.

4. The transmission device according to claim 2, wherein said calculation unit repeats calculation of the parameter until the parameter becomes at most the preset value, or said number of data to be the subject becomes a maximum that is determined in advance, while sequentially increasing the number of data to be the subject.

5. A transmission device conducting communication with predetermined quality ensured, comprising:
a classification unit classifying a packet of data to be transmitted according to each packet header,
a determination unit organizing a set of packets having the same packet header as a packet group according to a classified result by said classification unit, and determining whether to transmit with a bandwidth of said packet group ensured, and
a request unit requesting a bandwidth control device to reserve a bandwidth for a packet group,
wherein said determination unit calculates a buffer capacity required when a packet group is to be transmitted in a specific bandwidth, performing the calculation with the bandwidth changed, deriving a relationship between a required bandwidth and a required buffer capacity, and determining whether the packet group is a packet group to be transmitted with a bandwidth guaranteed from said relationship.

6. The transmission device according to claim 5, wherein said determination unit extracts a maximum value of the buffer capacity required for each requested bandwidth, and determines whether the packet group is a packet group to be transmitted with a bandwidth guaranteed depending upon whether a graph representing a relationship between a requested bandwidth and the maximum value of the required buffer capacity is within a predetermined region or not.

7. The transmission device according to claim 6, wherein said determination unit causes said request unit to request a bandwidth in said predetermined region, and requests a buffer unit to ensure the maximum value of the buffer capacity in said predetermined region.

8. The transmission device according to claim 7, wherein said determination unit determines the bandwidth to be requested and the buffer capacity to be ensured such that a total cost is minimized based on a cost required to ensure the bandwidth and a cost of the buffer capacity.

9. The transmission device according to claim 1, wherein, when determination is made by said determination unit that a packet group once determined to be transmitted with a bandwidth guaranteed is not observed for a predetermined time and is no longer necessary to ensure the bandwidth, said request unit requests said bandwidth control device to release the bandwidth guaranteed for the packet group.

10. The transmission device according to claim 1, wherein, when there is a change of at least a predetermined criterion in characteristics of a bit rate of a packet group once determined to be transmitted with a bandwidth guaranteed by said determination unit, said request unit requests said bandwidth control device to modify the bit rate of the bandwidth guaranteed for the packet group to the latest value.

11. The transmission device according to claim 1, wherein, when there is a change of at least a predetermined criterion in characteristics of a bit rate of a packet group once determined to be transmitted with a bandwidth guaranteed by said determination unit, said request unit requests said bandwidth control device to release the bandwidth guaranteed for said packet group.
